(19) United States
(12) Patent Application Publication
(10) Pub. No.: US 2017/0101350 A1
(43) Pub. Date: Apr. 13, 2017

(54) SYNTHETIC ACID COMPOSITIONS AND USES THEREOF

(71) Applicant: Fluid Energy Group Ltd., Calgary (CA)

(72) Inventors: Clay PURDY, Medicine Hat (CA); Darren THATCHER, High River (CA); Jon GARNER, Stony Plain (CA); Bruce ULMER, Stony Plain (CA)

(73) Assignee: Fluid Energy Group Ltd., Calgary (CA)

(21) Appl. No.: 15/314,204

(22) PCT Filed: May 28, 2015
(86) PCT No.: PCT/CA2015/000338

§ 371 Date: Nov. 28, 2016

(30) Foreign Application Priority Data
May 30, 2014 (CA) 2852729
Oct. 2, 2014 (CA) 2866510

(51) Int. Cl. C05C 9/00; A23L 2/68; A23C 21/00; C05G 3/04; C23G 1/08; C23F 11/14; C23G 1/04; C04B 41/53; C02F 1/66; A23J 3/10

(52) U.S. Cl. CPC C05C 9/00; C02F 1/66; A23L 2/68; A23C 21/00; A23J 3/10; C23G 1/08; C23F 11/142; C23G 1/04; C04B 41/5338; C04B 41/5315; C05G 3/04; C02F 2303/16; C02F 2303/22

(57) ABSTRACT

A synthetic acid composition for replacement of hydrochloric acid in industrial activities requiring large amounts of hydrochloric acid, said composition comprising: urea and hydrogen chloride in a molar ratio of not less than 0.1:1; a metal iodide or iodate; an alcohol or derivative thereof. Optionally, formic acid or a derivative thereof; propylene glycol or a derivative thereof, ethylene glycol glycerol or a mixture thereof; cinnamaldehyde or a derivative thereof; and a phosphonic acid derivative can be added to the composition.

### FIELD OF THE INVENTION

This invention relates to compositions for use in performing various operations in industries including, but not limited to, pulp & paper, mining, dairy, ion exchange bed regeneration, manufacturing, food-brewery-sugar production, concrete cleaning and textiles manufacturing more specifically to synthetic acid compositions as alternatives to HCl (hydrochloric acid).

### BACKGROUND OF THE INVENTION

Multiple industries work with HCl in large amounts and on a daily basis. One of the problems encountered with HCl (hydrochloric acid) is that it releases airborne toxins that can have serious side effects on plant and mill workers, as well as the environment in the surrounding area. For example, if hydrochloric acid is not properly filtered through air purification ducts and is released into the atmosphere, in its aerosol form hydrogen chloride gas is highly toxic and corrosive. So while the need for acids in industries will never diminish, the toxins released into the air and their exposure to humans and animals and the environment by their application needs to be.

It is advantageous to have an alternative to HCl that docs not create hydrogen chloride gas and has extremely low rates of corrosion. Hydrochloric acid is corrosive to the eyes, skin, and mucous membranes, as well as all metals. Acute (short-term) inhalation exposure may cause eye, nose, and respiratory tract irritation and inflammation and pulmonary edema in humans, that is irreversible. Acute oral exposure may cause corrosion of the mucous membranes, esophagus, and stomach and dermal contact may produce severe burns, ulceration, and scarring in humans. Chronic (long-term) occupational exposure to hydrochloric acid has been reported to cause gastritis, chronic bronchitis, dermatitis, and photosensitization in workers. Prolonged exposure to low concentrations may also cause dental discoloration and erosion.

There are many different mineral and organic acids used to perform various functions in these industries. A common type of acid employed is hydrochloric acid (HCl), which is useful in, but not limited to, cleaning scale or to lower the pH of a fluid. Corrosion and fumes are the major concerns when HCl is applied in industry. As an example, the total annual corrosion costs for the pulp, paper, and paperboard industry, as determined as a fraction of the maintenance cost, is estimated to be over $2.0 billion per year in the US alone. As another example, concrete trucks use acids to clean the dried concrete off of their trucks causing large amounts of corrosion resulting in significant maintenance costs. There is a high rate of human exposure as well in these industries. Therefore it is highly desirable to have a non-fuming product that has very low corrosion rates, is non-toxic and biodegradable that can replace the harsh acids typically utilized.

Paper production consists of a series of processes and can be roughly divided according to the five major manufacturing steps: (1) pulp production, (2) pulp processing and chemical recovery, (3) pulp bleaching, (4) stock preparation, and (5) paper manufacturing. Each manufacturing step has its own corrosion problems related to the size and quality of the wood fibers, the amount of and temperature of the process water, the concentration of the treatment chemicals, and the materials used for machinery construction. Examples of corrosion affecting production are: (1) corrosion products polluting the paper; and (2) corrosion of rolls leading to scarring of the sheets of paper. Corrosion of components may also result in fractures or leaks in the machines, causing production loss and safety hazards. Table 1 sets out the main chemicals and amounts release in total and on average in the pulp and paper industry.

TABLE 1
Top five highest amounts of toxics release inventory (TRI)
chemicals released in 1995 by pulp and paper facilities

| | TOTAL NUMBER | AVERAGE RELEASE |
|---|---|---|
| | OF RELEASES | PER FACILITY: |
| CHEMICAL | (in metric tons) | (in metric tons) |
| Methanol | 62,657 | 358 |
| Hydrochloric Acid | 11,022 | 68 |
| Ammonia | 6,643 | 34 |
| Sulfuric Acid | 5,864 | 40 |

In industries demanding purity (e.g. food, pharmaceutical, drinking water), high-quality hydrochloric acid is used to control the pH of process water streams. In less demanding industry, technical quality hydrochloric acid suffices for the neutralization of waste streams and for swimming pool treatment. It is desirable to have a synthetic option to HCl that is non-toxic, biodegradable and extremely low corrosion rates, as well as being non-fuming which can be safely handled and utilized in those industries.

Some major industrial uses of HCl include the food and dairy industry. In the food industry, hydrochloric acid is used in the manufacture of protein and starch. It is also used in demineralizing whey. Moreover, it is also extensively used in casein manufacturing, as well as the regeneration of ion exchange resins. Ion exchange resins are used to remove impurities in the production of corn syrups such as high-fructose corn syrup (HFCS). HFCS are widely used in the food industry but by far their largest use (upwards of 70%) is in the manufacturing of soft drinks. It is also used for hydrolyzing starch and proteins in the preparation of various food products. In the dairy industry, acid cleaners remove or prevent accumulated mineral deposits or milkstone buildup. It is advantageous to have an alternative to harsh acids that is non-hazardous and safe for human exposure.

As part of water treatment processes, hydrochloric acid is widely used as an effective neutralization agent for alkaline (high pH) effluent.

HCl is also used in neutralizing alkaline soils in agricultural and landscaping applications. It is also commonly used in the manufacture of fertilizers.

HCl is also used as an efflorescence cleaner for retaining walls, driveways, brick and as a mortar cleaner. It is also used to etch concrete which is typically treated with phosphoric acid. Phosphoric acid is another strong acid which emits toxic fumes irritating the nasal passages, eyes and skin.

HCl is also used as cement cleaner, more specifically in the removal of cement based material from equipment or structures as well as in the treatment of boiler scale, as well as being a scale cleaner applicable to ships, submarines, offshore vessels, and evaporators.

HCl can also be used as a catalyst and solvent in organic syntheses, as a laboratory reagent, for refining ore in the production of tin and tantalum among other minerals.

In the mining industry, there is heavy reliance on the acid leaching of certain minerals from ore deposits, an economical method of recovering valuable minerals from otherwise inaccessible bodies of ore. HCl is thus widely used in this industry as well.

Moreover, HCl is also used extensively in steel pickling. Steel pickling of carbon, alloy and stainless steels is a process where the acid removes surface impurities on steel. Such impurities include iron oxides and scale. The iron oxides are removed by contact with, the acid which solubilizes the oxides. Steel pickling is a necessary step in further processing steel products into such items as: wires, coating of sheet and strip as well as tin mill products. Other than pickling operations, HCl can also be used to perform aluminum etching, metal galvanizing, soldering and metal cleaning as well as a number of other operations.

HCl is also used in several retail applications as a component in typical household cleaners for cleaning tiles and sinks etc.

HCl is also commonly employed in the photographic and rubber industries, electronics manufacturing, as well as the textile industry in which waste from textile industries is rarely neutral. Certain processes such as reactive dyeing require large quantities of alkali but pre-treatments and some washes can be acidic. It is therefore necessary to adjust the pH in the treatment process to make the wastewater neutral. This is particularly important if biological treatment is being used, as the microbes used in biological treatment require a pH in the range of 6-8 and will be killed by highly acidic or alkali wastewater. In PCETP, the wastewater is mostly alkali wastes (high pH). For this purpose, hydrochloric acid (HCl) is added to maintain the pH value from 7.5 to 7.8 to save the microbes used in biological treatment as well as to reduce the wastage of chemicals. Therefore, it is advantageous to have an alternative pH control mechanism that is non-hazardous.

Some of the major challenges faced in various industries include the following: general high levels of corrosion due to the use of acids. These corrosion problems are typically countered by the addition of corrosion inhibitors that are typically themselves sometimes toxic and harmful to humans, the environment and or even the equipment. Reactions between acids and various types of metals can vary greatly, but softer metals, such as aluminum, are very susceptible to severe corrosion causing immediate damage. Toxicity levels of acids applied (including multiple additives used to control corrosion, emulsions, compatibility with oils/liquids, iron controls, water wetting agents etc.). Hydrochloric acid produces hydrogen chloride gas which is toxic, potentially fatal and corrosive to skin and metals. At levels above 50 ppm (part per million), hydrogen chloride gas can be Immediately Dangerous to Life and Health (IDHL). At levels ranging from 1300-2000 ppm, death can occur in 2-3 minutes.

The inherent environmental dangers (organic sterility, poisoning of wildlife etc.) of the use of acids in the event of an unintended/accidental release into water, aquifers or sources of water are devastating as they can cause significant pH reduction of such and can substantially increase the toxicity and could potentially cause a mass culling of aquatic species and potential poisoning of humans/livestock and wildlife exposed to/or drinking the water. An unintended surface release can also cause the release of a hydrogen chloride gas cloud, potentially endangering human and animal health. This is a common event at large storage sites when tanks split or leak or during a traffic accident involving an acid tanker. Typically, if near the public, large areas need to be evacuated post-event. Because of its acidic nature, hydrogen chloride gas is also corrosive, particularly in the presence of moisture.

The inability for acids and blends of such to biodegrade naturally results in expensive cleanup-reclamation costs for the operator should an unintended release occur. Moreover, the toxic fumes produced by mineral & organic acids are harmful to humans/animals and are highly corrosive and/or explosive potentially creating exposure dangers for personnel exposed to handling these harmful acids.

Another concern is the potential for spills on locations due to high corrosion levels of acids causing storage container failures and/or deployment equipment failures caused by high corrosion rates. Other concerns include: inconsistent strength or quality level of mineral & organic acids; potential supply issues based on industrial output levels; and ongoing risks to individuals handling acid containing containers.

Some issues associated with acids currently used in industry are price fluctuations with typical mineral and organic acids based on industrial output causing and users an inability to establish consistent long term costs in their respective budgets; severe reaction with dermal/eye tissue; major PPE requirements (personal protective equipment) for handling, such as on-site shower units; extremely high corrosion rates, especially as temperature increases, substantial storage and shipping costs and environmental damage during accidental release

When used to treat scaling issues on surface due to precipitation of minerals from most water sources, acids are exposed to humans and mechanical devices as well as expensive equipment causing increased risk for the operator and corrosion effects that damage equipment and create hazardous fumes. When mixed with bases or higher pH fluids, acids will create a large amount of thermal energy (exothermic reaction) causing potential safety concerns and equipment damage.

Typical organic and mineral acids used in a pH control situation can or will cause degradation of certain additives/systems requiring further chemicals to be added to counter these potentially negative effects. When using an acid to pickle steel, very careful attention must be paid to the process due to high levels of corrosion. Acids are very destructive to many typical elastomers found in various industries such as in water treatment/transfer pumps and seals utilized in the dairy/food processing industries. It is advantageous to have an HCl alternative that is preferably compatible with most common elastomers.

Acids perform many critical functions in various industries and are considered indispensable to achieve a desired result. However, the associated dangers that come with using acids are expansive and require substantial risk mitigation through various control measures (whether they are chemically or mechanically engineered) and are typically costly and complex and/or time-consuming.

Eliminating or even simply reducing the negative effects of acids while maintaining their usefulness is a struggle for the industry. As the public demand for the use of cleaner/safer/greener products increases, companies are looking for alternatives that perform the required function without all or most of the drawbacks associated with the use of conventional acids.

U.S. Pat. No. 4,402,852 discloses compositions containing 5 to 75% of urea, 5 to 85% of sulfuric acid and from 5 to 75% of water. These compositions are said to have reduced corrosiveness to carbon steels.

U.S. Pat. No. 6,147,042 discloses compositions comprising a polyphosphoric acid-urea condensate or polymer which results from the reaction of orthophosphoric acid and urea used in the removal of etching residue containing organometal residues.

U.S. Pat. No. 7,938,912 discloses compositions containing hydrochloric acid, urea, a complex substituted keto-amine-hydrochloride, an alcohol, an ethoxylate and a ketone for use to clean surfaces having cementitious compositions. U.S. Pat. Nos. 8,430,971 and 8,580,047 disclose and claim compositions containing specific amounts of hydrochloric acid (55% by wt); urea (42% by wt), a complex substituted keto-amine-hydrochloride (0.067% by wt); propargyl alcohol (0.067% by wt); an ethoxylated nonylphenyl (0.022% by wt); methyl vinyl ketone (0.022% by wt); acetone (0.0022% by wt); and acetophenone (0.0022% by wt) for use in specific oil industry applications, namely oil drilling and hydraulic fracturing.

U.S. Pat. No. 5,672,279 discloses a composition containing urea hydrochloride prepared by mixing urea and hydrochloric acid. Urea hydrochloride is used to remove scale in hot water boilers and other industrial equipment such as papermaking equipment. Scale is caused by the presence of calcium carbonate which is poorly soluble in water and tends to accumulate on surfaces and affect equipment exposed to it.

U.S. Pat. No. 4,466,893 teaches gelled acid compositions comprising a gelling agent selected from the group consisting of galactornannans such as guar gum, gum karaya, gum tragacanth, gum ghatti, gum acacia, gum konjak, shariz, locus, psyllium, tamarind, gum tara, carrageenan, gum kauri, modified guars such as hydroxypropyl guar, hydroxyethyl guar, carboxymethyl hydroxyethyl guar, carboxymethyl hydroxypropyl guar and alkoxylated amines. This patent teaches that presence of urea has a marked impact on the viscosity of the gelled acid and the gelled acid compositions are used in fracking activities.

Synthetic acid compositions are mostly applicable in the cleaning industry. However, such compositions require the additional of a number of various chemical compounds which can be dangerous in their undiluted states. The physical process to make such cleaning compositions involves multiple steps of mixing, blending and dilution. The present invention proposes the removal of certain chemicals used which would rationalize the process to make the compositions of the present invention and therefore render the manufacturing process safer from a production point of view. Moreover, it was discovered that the composition according to the present invention exhibits stability for operations at elevated temperature (above 65° C. to 100 C) and therefore makes them useful in various operations across several industries.

Consequently, there is still a need for compositions for use in various industries which can be used over a range of applications which will decrease a number of the associated dangers/issues typically associated with acid applications to the extent that, when properly used, these acid compositions are considered much safer for handling on worksites, as well as performance advantages such as the extremely low corrosion rates, the reaction rates, chemical compatibilities, shipping advantages and reduced storage costs.

The present invention provides a simpler manufacturing process and abridged synthetic acid compositions for use in high volume operations in various industrial settings where water usage and potential discharge into the environment is a concern.

### SUMMARY OF THE INVENTION

Compositions according to the present invention have been developed for, but not limited to, pulp & paper, mining, dairy, ion exchange bed regeneration, manufacturing, food-brewery-sugar production, concrete cleaning-etching and textiles manufacturing industries and associated applications, by targeting the problems of corrosion, logistics, storage, human/environmental exposure and equipment/fluid-product compatibilities.

It is an object of the present invention to provide a synthetic acid composition which can be used over a broad range of applications in these industries and which exhibit advantageous properties over HCl and other strong acids

According to one aspect of the present invention, there is provided a synthetic acid composition which, upon proper use, results in a very low corrosion rate on various industrial equipment.

According to another aspect of the present invention, there is provided a biodegradable synthetic acid composition for use in various industries.

According to another aspect of the present invention, there is provided a synthetic acid composition for use in industry which has a methodically spending (reacting) nature that is linear at higher temperature, non-fuming, non-toxic, high quality-consistent controlled.

According to another aspect of the present invention, there is provided a synthetic acid composition for use in industry which has minimal exothermic reactivity. Acids normally utilized in industrial operations typically have a high tendency to evaporate or fume, especially at higher concentrations. Preferred embodiments of the present invention do not exhibit this tendency and have very low fuming effect, even in at high concentration. Hydrochloric acid will produce hazardous fumes, such as chlorine gas, which can be fatal in higher concentrations. Preferred embodiments of the present invention do not produce hazardous fumes, in any concentration.

According to another aspect of the present invention, there is provided a synthetic acid composition for use in industry which is compatible with most existing industrial additives and equipment elastomers/seals.

According to another aspect of the present invention, there is provided a synthetic acid composition for use in various industries having a low evaporation rate. Acids normally utilized in industrial operations typically have a high tendency to evaporate or fume, especially at higher concentrations. Preferred embodiments of the present invention do not exhibit this tendency and have very low fuming effect, even in at high concentration. Hydrochloric acid will produce hazardous fumes, such as chlorine gas, which can be fatal in higher concentrations. Preferred embodiments of the present invention do not produce hazardous fumes, at any concentration.

According to another aspect of the present invention, there is provided a synthetic acid composition for use in industry which is reactive upon contact/application. Many acids that are considered safe have a slower reaction rate, a reduced capacity to solubilize, or a delayed reaction rate, making them ineffective or uneconomical in some applications. Strong mineral acids have very high hazards associated to them, but are immediately reactive. Preferred embodiments of the present invention are immediately active, even at lower concentrations. This immediate activity allows for a standard operating procedure to be followed, minimizing operational changes. Many activities that utilize a mineral acid, such as HCl, will not need to alter their standard operating procedure to utilize preferred compositions of the present invention.

According to another aspect of the present invention, there is provided a synthetic acid composition for use in industry which provides an easily adjustable, methodical and comprehensive reaction rate. In most industrial applications it is advantageous to have a more methodical reacting product as it will produce less potential for precipitation of minerals due to increased “free” room of a lower chloride fluid in the present invention. Preferred embodiments of the present invention have reaction rates that can be controlled or greatly “slowed or increased” for specific applications where a reduced (or increased) reaction rate is an advantage simply by adjusting the amount of water blended with the product. Preferred compositions of the present invention can be diluted substantially <10%, yet still remain effective in many applications, such as scale control, as well as further increasing the HSE benefits. As preferred compositions of the present invention are diluted the reaction rate, or solubilizing ability, of the product will remain linear.

According to an aspect of the present invention, there is provided a synthetic acid composition for use in the mining industry, the use being selected from, but not limited to, the group consisting of treating scale and adjusting pH levels in fluid systems.

According to another aspect of the present invention, there is provided a synthetic acid composition for use in the water treatment industry said use being selected from the group consisting of adjusting pH and neutralizing alkaline effluent.

According to another aspect of the present invention, there is provided a synthetic acid composition for use in the fertilizer/landscaping industry to adjust the pH level of a soil.

According to yet another aspect of the present invention, there is provided a synthetic acid composition for use to regenerate ion exchange beds.

According to an aspect of the present invention, there is provided a synthetic acid composition for use in the construction industry said use being selected from the group consisting of etching concrete and cleaning concrete off equipment or efflorescence build-up.

According to an aspect of the present invention, there is provided a synthetic acid composition for use in the electrical generation industry, said use being selected from the group consisting of descaling pipelines and related equipment and descaling facilities.

According to another, aspect of the present invention, there is provided a synthetic acid composition for use in the food and dairy industry, said use being selected from the group consisting of manufacturing protein, manufacturing starch, demineralizing whey, manufacturing casein, milk stone removal and regenerating ion exchange resins (water treatment).

According to another aspect of the present invention, there is provided a synthetic acid composition for use in the pool industry to lower the pH of fluids and clean scale.

According to an aspect of the present invention, there is provided a synthetic acid composition for use in the manufacturing industry to perform an operation selected from the group consisting of pickling steel and cleaning metals.

According to an aspect of the present invention, there is provided a synthetic acid composition for use in the retail industry as a low pH cleaning additive.

According to an aspect of the present invention, there is provided a synthetic acid which has an extremely low rate of corrosion on steel at low and high temperatures and aluminum at lower temperatures (25° C.).

Accordingly, the composition according to the present invention is intended to overcome many of the drawbacks found in the use of prior art compositions of HCl and other mineral acids in various industries.

According to an aspect of the invention, there is provided a synthetic acid composition comprising:
urea & hydrogen chloride in a molar ratio of not less than 0.1:1; preferably in a molar ratio not less than 0.5:1, more preferably in a molar ratio not less than 1.0:1;
a metal iodide or iodates, preferably cupric iodide, potassium iodide, lithium iodide or sodium iodide; in an amount ranging from 0.01-0.5%, preferably in an amount of approximately 0.022%; potassium iodide is the preferred compound;
an alcohol or derivative thereof, preferably alkynyl alcohol, more preferably a derivative of propargyl alcohol; in an amount ranging from 0.05-1.0%, preferably in an amount of approximately 0.25%; 2-Propyn-1-ol, complexed with methyloxirane is the preferred component;
optionally, cinnamaldehyde or a derivative amine thereof; present in an amount ranging from 0.01-1.0%, preferably in an amount of approximately 0.03%; cinnamaldehyde is the preferred compound;
optionally, a formic add or a derivative thereof selected from the group consisting of acetic acid, ethylformate and butyl formate are present in an amount ranging from 0.05-2.0%, preferably in an amount of approximately 0.1%; formic acid is the preferred compound;
optionally a propylene glycol or a derivative thereof present in an amount ranging from 0.05-1.0%, preferably in an amount of approximately 0.05%; propylene glycol is the preferred compound; and
optionally, a phosphonic acid or derivatives, preferably alkylphosphoric acid or derivatives thereof and more preferably amino tris methylene phosphonic acid and derivatives thereof.

### DETAILED DESCRIPTION OF THE PREFERRED EMBODIMENTS

The description that follows, and the embodiments described therein, is provided by way of illustration of an example, or examples, of particular embodiments of the principles of the present invention. These examples are provided for the purposes of explanation, and not limitation, of those principles and of the invention.

Urea-HCl is the main component in terms of volume and weight percent of the composition of the present invention, and consists basically of a carbonyl group connecting with nitrogen and hydrogen. When added to hydrochloric acid, there is a reaction that results in urea hydrochloride, which basically traps the chloride ion within the molecular structure. This reaction greatly reduces the hazardous effects of the hydrochloric acid on its own, such as the fuming effects, the hygroscopic effects, and the highly corrosive nature (the Cl− ion will not readily bond with the Fe ion). The excess nitrogen can also act as a corrosion inhibitor at higher temperatures. Urea & Hydrogen chloride in a molar ratio of not less than 0.1:1; preferably in a molar ratio not less than 0.5:1, and more preferably in a molar ratio not less than 1.0:1. However, this ratio can be increased depending on the application.

It is preferable to add the urea at a molar ratio greater than 1 to the moles of HCl acid (or any acid). This is done in order to bind any available ions, thereby creating a safer, more inhibited product. Preferably, the composition according to the present invention comprises 1.05 moles of urea per 1.0 moles of HCl. The urea (hydrochloride) also allows for a reduced rate of reaction when in the presence of carbonate-based materials. This again due to the stronger molecular bonds associated over what hydrochloric acid traditionally displays. Further, since the composition according to the present invention is mainly comprised of urea (which is naturally biodegradable), the product testing has shown that the urea hydrochloride will maintain the same biodegradability function, something that hydrochloric acid will not on its own.

Alcohols and derivatives thereof, such as alkyne alcohols and derivatives and preferably propargyl alcohol and derivatives thereof can be used as corrosion inhibitors. Propargyl alcohol itself is traditionally used as a corrosion inhibitor which works extremely well at low concentrations. It is however a very toxic/flammable chemical to handle as a concentrate, so care must be taken when exposed to the concentrate. In the composition according to the present invention, it is preferred to use 2-Propyn-1-ol, complexed with methyloxirane, as this is a much safer derivative to handle.

Metal iodides or iodates such as potassium iodide, sodium iodide, cuprous iodide and lithium iodide can potentially be used as corrosion inhibitor intensifier. In fact, potassium iodide is a metal iodide traditionally used as corrosion inhibitor intensifier, however it is expensive, but works extremely well. It is non-regulated and friendly to handle as well.

Phosphonic acids and derivatives such as amino tris methylene phosphonic acid (ATMP) have some value as scale inhibitors. In fact, ATMP is a chemical traditionally used as an oilfield scale inhibitor, it has been found, when used in combination with urea/HCl, to increase the corrosion inhibition or protection. It has a good environmental profile, is readily available and reasonably priced.

Amino tris (methylenephosphonic acid) (ATMP) and its sodium salts are typically used in water treatment operations as scale inhibitors. They also find use as detergents and in cleaning applications, in paper, textile and photographic industries and in off-shore oil applications. Pure ATMP presents itself as a solid but it is generally obtained through process steps leading to a solution ranging from being colourless to having a pale yellow colour. ATMP acid and some of its sodium salts may cause corrosion to metals and may cause serious eye irritation to a varying degree dependent upon the pH/degree of neutralization.

ATMP must be handled with care when in its pure form or not in combination with certain other products. Typically, ATMP present in products intended for industrial use must be maintained in appropriate conditions in order to limit the exposure at a safe level to ensure human health and environment.

Amino tris (methylenephosphonic acid) and its sodium salts belong to the ATMP category in that all category members are various ionized forms of the acid. This category includes potassium and ammonium salts of that acid. The properties of the members of a category are usually consistent. Moreover, certain properties for a salt, in ecotoxicity studies, for example, can be directly appreciated by analogy to the properties of the parent acid. Amino tris (methylenephosphonic acid) may specifically be used as an intermediate for producing the phosphonates salts. The salt is used in situ (usually the case) or stored separately for further neutralization. One of the common uses of phosphonates is as scale inhibitors in the treatment of cooling and boiler water systems. In particular, for ATMP and its sodium salts are used in to prevent the formation of calcium carbonate scale.

The use of formic acid as corrosion inhibitor has been known for decades. However, the high concentrations in which its use has been reported along with the compounds it has been intermixed with have not made it a desirable compound in many applications. Prior art compositions containing formic acid require the presence of quinoline containing compounds or derivatives thereof, which render their, use, in an increasingly environmentally conscious world, quite restricted.

In the present invention, formic acid or a derivative thereof such as formic acid, acetic acid, ethylformate and butyl formate can be added in an amount ranging from 0.05-2.0%, preferably in an amount of approximately 0.1%. Formic acid is the preferred compound.

In preferred embodiments of the present invention, 2-Propyn-1-ol, complexed with methyloxirane can be present in a range of 0.05-1.0%, preferably it is present in an amount of approximately 0.25%. Potassium Iodide can be present in a range of 0.01-0.5%, preferably it is present in an amount of approximately 0.022%. Formic Acid can be present in a range of 0.05-2.0%, preferably it is present in an amount of approximately 0.1%. Propylene Glycol can be present in a range of 0.05-1.0%, preferably it is present in an amount of approximately 0.05%. Cinnamaldehyde can be present in a range of 0.01-1.0%, preferably it is present in an amount of approximately 0.03%.

As a substitute for traditional propargyl alcohol, a preferred embodiment of the present invention uses 2-Propyn-1-ol, complexed with methyloxirane. As a substitute for potassium iodide one could use sodium iodide, copper iodide and lithium iodide. However, potassium iodide is the most preferred. As a substitute for formic acid one could use acetic acid. However, formic acid is most preferred. As a substitute for propylene glycol one could use ethylene glycol, glycerol or a mixture thereof. Propylene glycol being the most preferred. As a substitute for cinnamaldehyde one could use cinnamaldehyde derivatives and aromatic aldehydes selected from the group consisting of: dicinnamaldehyde p-hydroxycinnamaldehyde; p-methylcinnamaldehyde; p-ethylcinnamaldehyde; p-methoxycinnamaldehyde; p-dimethylaminocinnamaldehyde; p-diethylaminocinnamaldehyde; p-nitrocinnamaldehyde; o-nitrocinnamaldehyde; 4-(3-propenal)cinnamaldehyde; p-sodium sulfocinnamaldehyde p-trimethylammoniumcinnamaldehyde sulfate; p-trimethylammoniumcinnamaldehyde o-methylsulfate; p-thiocyanocinnamaldehyde; p-(S-acetyl)thiocinnamaldehyde p-(S—N,N-dimethylcarbamoylthio)cinnamaldehyde; p-chlorocinnamaldehyde; α-methylcinnamaldehyde; β-methylcinnamaldehyde; α-chlorocinnamaldehyde α-bromocinnamaldehyde; α-butylcinnamaldehyde; α-amylcinnamaldehyde; α-hexylcinnamaldehyde; α-bromo-p-cyanocinnamaldehyde; α-ethyl-p-methylcinnamaldehyde and p-methyl-α-pentylcinnamaldehyde. The most preferred is cinnamaldehyde.

### Example 1—Process to Prepare a Composition According to a Preferred Embodiment of the Invention

Start with a 50% by weight solution of pure urea liquor. Add a 36% by weight solution of hydrogen chloride while circulating until all reactions have completely ceased. The ATMP is then added followed by propargyl alcohol, and potassium iodide. Circulation is maintained until all products have been solubilized. Additional products are added now as required (if required). Table 2 lists the components of the composition of Example 1, including their weight percentage as compared to the total weight of the composition and the CAS numbers of each component.

TABLE 2
Composition of a preferred embodiment of the present invention

| Chemical | % Wt Composition | CAS# |
|---|---|---|
| Water | 60.315 | 7732-18-5 |
| Urea Hydrochloride | 39.0% | 506-89-8 |
| Amino tris methylene | 0.576% | 6419-19-8 |
| phosphonic acid | | |
| Propargyl Alcohol | 0.087% | 107-19-7 |
| Potassium Iodide | 0.022% | 7681-11-0 |

The resulting composition of Example 1 is a clear, odourless liquid having shelf-life of greater than 1 year. It has a freezing point temperature of approximately minus 30° C. and a boiling point temperature of approximately 100° C. It has a specific gravity of 1.15±0.02. It is completely soluble in water and its pH is less than 1.

The composition is biodegradable and is classified as a non irritant according to the classifications for skin tests. The composition is non-fuming and has no volatile organic compounds nor does it have any BTEX levels above the drinking water quality levels. BTEX refers to the chemicals benzene, toluene, ethylbenzene and xylene. Toxicity testing was calculated using surrogate information and the LD₅₀ was determined to be greater than 2000 mg/kg.

With respect to the corrosion impact of the composition on typical industrial grade steel, it was established that it was clearly well below the acceptable corrosion limits set by industry for certain applications, including, but not limited to scale treatments, pH control, ion regeneration and concrete truck cleaning.

### Example 2

Table 3 lists the components of the composition of Example 2 including their weight percentage as compared to the total weight of the composition and the CAS numbers of each component.

TABLE 3
Composition according to an embodiment of the present invention

| Chemical | % Wt Composition | CAS# |
|---|---|---|
| Water | 58.92% | 7732-18-5 |
| Urea Hydrochloride | 40.6% | 506-89-8 |
| 2-Propyn-1-ol, complexed | 0.2% | 38172-91-7 |
| with methyloxirane | | |
| Potassium Iodide | 0.05% | 7681-11-0 |
| Formic Acid | 0.15% | 64-18-6 |
| Propylene Glycol | 0.05% | 57-55-6 |
| Cinnamaldehyde | 0.03% | 14371-10-9 |

### Aquatic Toxicity Testing

The biological test method that was employed was the Reference Method for Determining acute lethality using rainbow trout (1990—Environment Canada, EPS I/RM/9—with the May 1996 and May 2007 amendments).

The Trout 96 hour Acute Test (WTR-ME-041) was performed at 5 different concentrations of compositions (62.5, 125, 250, 500 and 1000 ppm) one replicate per treatment, ten fish per replicate.

The test results indicate that at concentrations of the composition of Example 2 of up to and including 500 ppm there was a 100% survival rate in the fish sample studied. This is an indicator that the composition of Example 2 demonstrates an acceptable environmental safety profile.

### Dermal Testing

The objective of this study was to evaluate the dermal irritancy and corrosiveness of the composition of Example 2, following a single application to the skin of New Zealand White rabbits. The undiluted test substance was placed on the shaved back of each of the three rabbits used in the study. The treated site was then covered by a gauze patch and secured with porous tape. The entire midsection of each rabbit was wrapped in lint-free cloth secured by an elastic adhesive bandage. The untreated skin site of each rabbit served as a control for comparison purposes. All wrapping materials were removed from each rabbit 4 hours following application of the test substance. The application site was then rinsed with water and wiped with gauze to remove any residual test substance. The skin of each rabbit was examined at 30-60 minutes and 24, 48 and 72 hours following removal of the wrappings. Descriptions of skin reactions were recorded for each animal. Dermal irritation scores were calculated for each time point, and a Primary Dermal Irritation Score was calculated according to the Draize descriptive ratings for skin irritancy.

Tables 4 and 5 report the results of the dermal testing. The scores for edema and erythema/eschar formation were “0” at all scoring intervals for all three rabbits. According to the Draize descriptive ratings for skin irritancy, the Primary Dermal Irritation Score (based on the 24- and 72-hour scoring intervals) for the test substance under the conditions employed in this study was 0.00. Thus, the composition of Example 2 was determined to be a non-irritant to the skin of New Zealand White rabbits. However, this conclusion was drawn without characterization of the test substance.

TABLE 4
Description of Individual Skin Reactions
upon exposure to composition of Example 2

| | | Scoring Interval | | | |
|---|---|---|---|---|---|
| | | (Time Following Removal of Wrappings) | | | |
| Animal | | 30-60 | 24 | 48 | 72 |
| Number | | Minutes | Hours | Hours | Hours |
| (sex) | | Skin Reactions Scores | | | |
| 819 (F) | Edema^{b} | 0 | 0 | 0 | 0 |
| | Erythema/eschar^{c} | 0 | 0 | 0 | 0 |
| 820 (F) | Edema | 0 | 0 | 0 | 0 |
| | Erythema/eschar | 0 | 0 | 0 | 0 |
| 821 (F) | Edema | 0 | 0 | 0 | 0 |
| | Erythema/eschar | 0 | 0 | 0 | 0 |

^{a} see protocol Table 1 (Appendix A) for a detailed description of the Draize scoring scale (Draize, J. H., Appraisal of the Safety of Chemicals in Foods, Drugs, and Cosmetics, Assoc. Food & Drug Officials of the U.S., Austin, TX, 1959)
^{b}edema: 0 = none, 1 = very slight, 2 = slight, 3 = moderate, 4 (maximum possible) = severe
^{c}erythema/eschar: 0 = none, 1 = very slight, 2 = well-defined, 3 = moderate to severe, 4 (maximum possible) = severe erythema to slight eschar formation

TABLE 5
Primary Dermal Irritation Score of Individual Skin
Reactions upon exposure to composition of Example 2

| | Scoring Interval | | | |
|---|---|---|---|---|
| | (Time Following Removal of Wrappings) | | | |
| | 30-60 | 30-60 | 30-60 | 30-60 |
| | Minutes | Minutes | Minutes | Minutes |
| | Skin Reactions Scores Summary^{b} | | | |
| Edema Score | | | | |
| 0 | 3/3 | 3/3 | 3/3 | 3/3 |
| 1 | 0/3 | 0/3 | 0/3 | 0/3 |
| 2 | 0/3 | 0/3 | 0/3 | 0/3 |
| 3 | 0/3 | 0/3 | 0/3 | 0/3 |
| 4 | 0/3 | 0/3 | 0/3 | 0/3 |
| Positive Score Mean | 0.00 | 0.00 | 0.00 | 0.00 |
| Erythema and/or Eschar | | | | |
| Formation Score | | | | |
| 0 | 3/3 | 3/3 | 3/3 | 3/3 |
| 1 | 0/3 | 0/3 | 0/3 | 0/3 |
| 2 | 0/3 | 0/3 | 0/3 | 0/3 |
| 3 | 0/3 | 0/3 | 0/3 | 0/3 |
| 4 | 0/3 | 0/3 | 0/3 | 0/3 |
| Positive Score Mean | 0.00 | 0.00 | 0.00 | 0.00 |
| Irritation Score | 0.00 | 0.00 | 0.00 | 0.00 |
| Subtotal^{c} | | | | |

| | |
|---|---|
| PRIMARY DERMAL | 0.00 (24-hour subtotal) + 0.00 (72-hour |
| IRRITATION SCORE | subtotal) = 0.00 (total score) |
| (DRAIZE): | 0.00 (total score)/2 = 0.00 (Primary |
| | Dermal Irritation Score) |

^{a} see protocol Table 1 (Appendix A) for a detailed description of the Draize scoring scale (Draize, J. H., Appraisal of the Safety of Chemicals in Foods. Drugs, and Cosmetics, Assoc. Food & Drug Officials of the U.S., Austin, TX, 1959)
^{b}Number of animals with score/number of animals dosed
^{c}Irritation score subtotal = mean erythema score + mean edema score

### Corrosion Testing

Corrosion testing using the composition of Example 2 was carried out under various conditions of temperature and on different steels to show the breadth of the applications for which compositions according to the present invention can be used. Table 6 sets out the test results of corrosion test that were carried out on N-80 steel (density of 7.86 g/cc) using the composition of Example 2 at a 50% concentration. Table 7 reports the test results of corrosion tests that were carried out on J-55 steel (density of 7.86 g/cc) using the composition of Example 2 at a 50% concentration. Table 8 reports the test results of corrosion tests that were carried out on various metal samples using the composition of Example 2 at a 100% concentration. These test results show that the composition of Example 2 meets the regulatory standards for the transportation industry on mild steel, and provide a strong level of protection with respect to aluminum.

TABLE 6
Corrosion tests carried out on N-80 steel (density of 7.86 g/cc) using the composition
of Example 2 at a 50% concentration

| | | Final | Loss | Surface | Run | | | |
|---|---|---|---|---|---|---|---|---|
| Temp | Initial Wt. | wt. | wt. | Area | Time | | | |
| ° C. | (g) | (g) | (g) | (cm2) | (hours) | Mils/yr | mm/year | lb/ft2 |
| 70° C. | 40.898 | 40.863 | 0.035 | 27.11 | 6 | 94.41353 | 2.398 | 0.003 |
| 70° C. | 40.898 | 40.816 | 0.082 | 27.11 | 24 | 55.29936 | 1.405 | 0.006 |
| 90° C. | 40.896 | 40.838 | 0.058 | 27.11 | 6 | 156.4567 | 3.974 | 0.004 |
| 90° C. | 40.896 | 40.740 | 0.156 | 27.11 | 24 | 105.2037 | 2.672 | 0.011 |

TABLE 7
Corrosion tests carried out on J-55 steel (density of 7.86 g/cc) using the composition
of Example 2 at a 50% concentration

| | | Final | Loss | Surface | Run | | | |
|---|---|---|---|---|---|---|---|---|
| Temp | Initial Wt. | wt. | wt. | Area | Time | | | |
| ° C. | (g) | (g) | (g) | (cm2) | (hours) | Mils/yr | mm/year | lb/ft2 |
| 30° C. | 37.705 | 37.700 | 0.005 | 28.922 | 6 | 12.64263 | 0.321 | 0.000 |
| 30° C. | 37.705 | 37.692 | 0.013 | 28.922 | 24 | 8.217709 | 0.209 | 0.001 |
| 30° C. | 37.705 | 37.676 | 0.029 | 28.922 | 72 | 6.110604 | 0.155 | 0.002 |
| 50° C. | 37.513 | 37.502 | 0.011 | 28.922 | 6 | 27.81378 | 0.706 | 0.001 |
| 50° C. | 37.513 | 37.485 | 0.028 | 28.922 | 24 | 17.69968 | 0.450 | 0.002 |
| 70° C. | 37.435 | 37.396 | 0.039 | 28.922 | 6 | 98.61251 | 2.505 | 0.003 |
| 70° C. | 37.435 | 37.350 | 0.085 | 28.922 | 24 | 53.73117 | 1.365 | 0.006 |
| 90° C. | 37.514 | 37.430 | 0.084 | 28.922 | 6 | 212.3962 | 5.395 | 0.006 |
| 90° C. | 37.514 | 37.255 | 0.259 | 28.922 | 24 | 163.7221 | 4.159 | 0.018 |

TABLE 8
Corrosion tests carried out on various metal samples using the composition of
Example 2 at a 100% concentration

| | | Initial | Final | Loss | Surface | | Run | | | |
|---|---|---|---|---|---|---|---|---|---|---|
| | Temp | Wt. | wt. | wt. | Area | Density | Time | | | |
| Coupon | ° C. | (g) | (g) | (g) | (cm2) | g/cc | (hours) | Mils/yr | mm/year | lb/ft2 |
| 1018 | 55° C. | 13.994 | 13.955 | 0.039 | 28.503 | 7.82 | 72 | 8.381163 | 0.213 | 0.003 |
| steel | | | | | | | | | | |
| 7075 | 25° C. | 6.196 | 6.185 | 0.011 | 29.471 | 2.81 | 6 | 76.35013 | 1.939 | 0.001 |
| aluminum | | | | | | | | | | |
| 7075 | 25° C. | 6.196 | 6.080 | 0.116 | 29.471 | 2.81 | 24 | 201.2867 | 5.113 | 0.008 |
| aluminum | | | | | | | | | | |
| 7075 | 25° C. | 6.196 | 1.344 | 4.852 | 29.471 | 2.81 | 48 | 4209.668 | 106.926 | 0.344 |
| aluminum | | | | | | | | | | |

### Example 3

Table 9 lists the components of the composition of Example 3 including their weight percentage as compared to the total weight of the composition and the CAS numbers of each component.

TABLE 9
Composition of a preferred embodiment of the present invention

| Chemical | % Wt Composition | CAS# |
|---|---|---|
| Water | 59.028% | 7732-18-5 |
| Urea Hydrochloride | 40.6% | 506-89-8 |
| 2-Propyn-1-ol, complexed | 0.25% | 38172-91-7 |
| with methyloxirane | | |
| Potassium Iodide | 0.022% | 7681-11-0 |
| Formic Acid | 0.1% | 64-18-6 |

### Corrosion Testing

The compositions of Example 2 and 3 according to the present invention were exposed to corrosion testing. The results of the corrosion tests are reported in Table 10.

Samples of J55 grade steel were exposed to various synthetic acid solutions for periods of time ranging up to 24 hours at 90° C. temperatures. All of the tested compositions contained HCl and urea in a 1:1.05 ratio.

TABLE 10
Corrosion testing comparison between HCl-Urea and the compositions of Example 2 and
3 at a 100% concentration

| | | | Loss | Surface | | Run | | | |
|---|---|---|---|---|---|---|---|---|---|
| | Initial | Final | wt. | area | Density | time | | | |
| Inhibitor (%) | wt. (g) | wt. (g) | (g) | (cm2) | (g/cc) | (hours) | Mils/yr | mm/year | lb/ft² |
| HCl-Urea | 37.616 | 34.524 | 3.092 | 28.922 | 7.86 | 6 | 7818.20 | 198.582 | 0.222 |
| HCl-Urea | 37.616 | 31.066 | 6.550 | 28.922 | 7.86 | 24 | 4140.46 | 105.168 | 0.470 |
| Example #2 | 37.524 | 37.313 | 0.211 | 28.922 | 7.86 | 6 | 533.519 | 13.551 | 0.015 |
| Example #2 | 37.524 | 35.540 | 1.984 | 28.922 | 7.86 | 24 | 1254.149 | 31.855 | 0.142 |
| Example #3 | 37.714 | 37.520 | 0.194 | 28.922 | 7.86 | 6 | 490.534 | 12.460 | 0.014 |
| Example #3 | 37.714 | 37.329 | 0.385 | 28.922 | 7.86 | 24 | 243.371 | 6.182 | 0.027 |

This type of corrosion testing helps to determine the impact of the use of such synthetic replacement acid composition according to the present invention compared to the industry standard (HCl blends or any other mineral or organic acid blends). The results obtained for the composition containing only HCl and urea were used as a baseline to compare the other compositions. Additionally, the compositions according to the present invention will allow the end user to utilize an alternative to conventional acids that has the down-hole performance advantages, transportation and storage advantages as well as the health, safety and environmental advantages. Enhancement in short/long term corrosion control is one of the key advantages of preferred embodiments of the present invention. The reduction in skin corrosiveness, the elimination of corrosive fumes, the controlled spending nature, and the high salt tolerance are other advantages of preferred compositions according to the present: invention.

### Aquatic Toxicity Testing

The biological test method that was employed was the Reference Method for Determining acute lethality using rainbow trout (1990—Environment Canada, EPS I/RM/9—with the May 1996 and May 2007 amendments).

The Trout 96 hour Acute Test (WTR-ME-041) was performed at 5 different concentrations of compositions (62.5, 125, 250, 500 and 1000 ppm) one replicate per treatment, ten fish per replicate.

The test results indicate that at concentrations of the composition of Example 3 of up to and including 500 ppm there was a 100% survival rate in the fish sample studied. This is an indicator that the composition of Example 3 demonstrates a highly acceptable environmental safety profile.

Additional testing was carried out to assess the inhibition of marine algal growth, acute toxicity and biodegradability establish the safely for the environment.

### Corrosion Testing

Corrosion testing using the composition of Example 3 was carried out under various conditions of temperature and on different steels to show the breadth of the applications for which compositions according to the present invention can be used. Table 11 sets out the test results of corrosion test that were carried out on N-80 steel (density of 7.86 glee) using the composition of Example 3 at a 50% concentration. Table 12 reports the test results of corrosion tests that were carried out on J-55 steel (density of 7.86 g/cc) using the composition of Example 3 at a 50% concentration. Table 13 reports the test results of corrosion tests that were carried out on various metal samples using the composition of Example 3 at a 100% concentration. These test results show that the composition of Example 3 meets the regulatory standards for the transportation industry on mild steel, and provide a strong level of protection with respect to aluminum.

TABLE 11
Corrosion tests carried out on N-80 steel (density of 7.86 g/cc) using the composition
of Example 3 at a 50% concentration

| | | | | Surface | | Run | | | |
|---|---|---|---|---|---|---|---|---|---|
| Temp | Initial Wt. | Final wt. | Loss wt. | Area | Density | Time | | | |
| ° C. | (g) | (g) | (g) | (cm2) | g/cc | (hours) | Mils/yr | mm/year | lb/ft2 |
| 70° C. | 40.757 | 40.708 | 0.049 | 27.11 | 7.86 | 6 | 132.1789 | 3.357 | 0.003 |
| 70° C. | 40.757 | 40.609 | 0.148 | 27.11 | 7.86 | 24 | 99.80859 | 2.535 | 0.010 |
| 90° C. | 40.712 | 40.617 | 0.095 | 27.11 | 7.86 | 6 | 256.2653 | 6.509 | 0.007 |
| 90° C. | 40.712 | 40.475 | 0.237 | 27.11 | 7.86 | 24 | 159.8286 | 4.060 | 0.017 |

TABLE 12
Corrosion tests carried out on J-55 steel (density of 7.86 g/cc) using the composition
of Example 3 at a 50% concentration

| | Initial | Final | Loss | Surface | | Run | | | |
|---|---|---|---|---|---|---|---|---|---|
| Temp | Wt. | wt. | wt. | Area | Density | Time | | | |
| ° C. | (g) | (g) | (g) | (cm2) | g/cc | (hours) | Mils/yr | mm/year | lb/ft2 |
| 50° C. | 38.366 | 38.342 | 0.024 | 28.922 | 7.86 | 6 | 60.68462 | 1.541 | 0.002 |
| 50° C. | 38.366 | 38.323 | 0.043 | 28.922 | 7.86 | 24 | 27.18165 | 0.690 | 0.003 |
| 70° C. | 38.728 | 38.596 | 0.132 | 28.922 | 7.86 | 6 | 333.7654 | 8.478 | 0.009 |
| 70° C. | 38.728 | 38.448 | 0.280 | 28.922 | 7.86 | 24 | 176.9968 | 4.496 | 0.020 |
| 90° C. | 37.543 | 37.463 | 0.080 | 28.922 | 7.86 | 6 | 202.2821 | 5.138 | 0.006 |
| 90° C. | 37.543 | 37.106 | 0.437 | 28.922 | 7.86 | 24 | 276.2415 | 7.017 | 0.031 |

TABLE 13
Corrosion tests carried out on various metal samples using the composition of
Example 3 at a 100% concentration

| | | Initial | Final | Loss | Surface | | Run | | | |
|---|---|---|---|---|---|---|---|---|---|---|
| | Temp | Wt. | wt. | wt. | Area | Density | Time | | | |
| Coupon | ° C. | (g) | (g) | (g) | (cm2) | g/cc | (hours) | Mils/yr | mm/year | lb/ft2 |
| 1018 | 55° C. | 13.994 | 13.955 | 0.039 | 28.503 | 7.82 | 72 | 8.381163 | 0.213 | 0.003 |
| steel | | | | | | | | | | |
| 7075 | 25° C. | 6.196 | 6.080 | 0.116 | 29.471 | 2.81 | 24 | 201.2867 | 5.113 | 0.008 |
| aluminum | | | | | | | | | | |
| 7075 | 25° C. | 6.196 | 1.344 | 4.852 | 29.471 | 2.81 | 48 | 4209.668 | 106.926 | 0.344 |
| aluminum | | | | | | | | | | |

### Elastomer Testing

When common sealing elements used in various industries come in contact with acid compositions they tend to degrade or at least show sign of damage. A number of sealing elements common in industrial activities were exposed to a composition according to a preferred embodiment of the present invention to evaluate the impact of the latter on their integrity. More specifically, the hardening and drying and the loss of mechanical integrity of sealing elements can have substantial consequences on the efficiency of certain processes as breakdowns require the replacement of defective sealing elements. Testing was carried out to assess the impact of the exposure of composition of Example 3 to various elastomers. Long term (72 hour exposure) elastomer testing on the concentrated product of Example 3 at 70° C. and 28,000 kPa showed little to no degradation of various elastomers, including Nitrile 70, Viton 75, Aflas 80, and EPDM 70 style sealing elements.

The uses (or applications) of the compositions according to the present invention upon dilution thereof ranging from approximately 1 to 75% dilution, include, but are not limited to: water treatment; boiler/pipe de-scaling; soil treatment; pH control; ion regeneration; pipeline scale treatments; pH control; retail cleaner; cement etching; concrete truck cleaning; soil pH control and various pulp and paper industrial applications. It is understood that other uses or applications within the various industries discussed previously can be accomplished using the compositions according to the present invention.

### Use of a Composition According to the Present Invention for Etching Floor Surfaces

Prior to coatings being applied to concrete floors, the surface must be clean, free of contaminants and abraded to obtain maximum adhesion. The standard technique involves applying an acid solution diluted in water and applied directly to the concrete. Since concrete is alkaline, a reaction takes places, and a vigorous formation and release of irritating and/or toxic gas occurs when the acid solution comes into contact with the cement. The residue is then rinsed with fresh water. When done properly the concrete surface will have a texture similar to sandpaper. Using conventional mineral acids puts employees and equipment at risk due to the corrosive nature of the acids, as well as an aggressive fuming characteristic.

Testing was conducted on floor surfaces and results were noted.

During the etching process the composition according to a preferred embodiment of the present invention was in a diluted version (at 33% synthetic acid composition according to the present invention to 67% water). As the composition used is a non-fuming product it did not release dangerous fumes nor did it cause corrosion to any equipment in the vicinity. The process was straightforward and it consisted in simply pre-mixing the product with the appropriate quantity of water and apply via spray pump (agitation provided increased permeability). Once applied, the product is left to react for a few minutes, then is rinsed off and the surface is left to dry.

This composition replaces the harsh muriatic and phosphoric acids prevalent in the industry which are toxic, require substantial personal protective equipment and which require great care to eliminate runoff during the cleanup process. Some municipalities have banned hydrochloric acid from being discharged into the environment and sewer systems.

Some of the advantages that were noted include the reduction of repairs and maintenance with regards to application equipment (sprayers etc.) increased safety for the employees. Moreover, the after-treatment clean up time is reduced due to less rinsing effort required compared to mineral acids. As well, the user spent less time handling the product since a highly corrosive products requires a great deal more safeguards, than it does when using a composition according to the present invention, used in the present instance.

This composition is non-fuming, non-corrosive, non-toxic and biodegradable.

### Use of a Composition According to the Present Invention as a Hull Cleaner

As boats are exposed to fresh and salt water, minerals build up on the hull and engine drives, as well as in internal engine parts such as in heat exchangers. The standard technique to deal with the scale involves applying a hydrochloric acid solution diluted in water and applied directly to the boats hull. Using conventional mineral acids puts the environment, employees and equipment at risk due to the corrosive nature of the acids, as well as an aggressive fuming characteristic. Prior to application boats need to be removed from the water as most marinas throughout the world will not allow toxic products to be applied while still in the water.

The hull cleaning composition according to a preferred embodiment of the present invention is one of the most aggressive cleaner of its type, yet remains safe for boat surfaces and the environment.

This composition removed as much calcium buildup as hydrochloric acid, but did not harm the hull when applied properly. The composition was so strong and effective that it removed barnacles and other calcium life forms. The composition was applied without being. The hull cleaning composition potentially can be applied in the water on a lift as it is biodegradable and non-toxic (depending on local regulations).

Some of the main features of the composition include the fact that it is biodegradable, environmentally safe, non-toxic, non-fuming and non-hazardous.

Also noteworthy of mention is that use of this composition according to the present invention can lead to a reduction of logistics (removing large craft from the water) and maintenance with regards to the equipment used in the application (sprayers etc.), as well as safe storage of bulk product for industrial users (non-hazardous). Additionally, increased safety for the employees/customers is another major advantage of this composition according to the present invention. Also, after-treatment clean up time is reduced due to less clean-up effort required (spent product capture), compared to mineral acids.

### Use of Composition According to the Present Invention as a Concrete Truck Cleaner

As concrete trucks are exposed to their product, minerals build up on the body, drying and become very difficult to remove. The standard technique to deal with the dried concrete involves applying a hydrochloric acid solution (or similar strong acid) diluted in water and applied directly to the trucks body parts. Using conventional mineral acids puts the environment, employees and equipment at risk due to the corrosive nature of the acids, as well as an aggressive fuming characteristic.

Corrosion is a major problem for this industry as well as the high human exposure factor (as trucks are typically washed by hand). As well, chemical residue runoff is difficult to treat and contain.

The concrete cleaning composition according to a preferred embodiment of the present invention, is one of the most aggressive cleaners of its type (as effective as a strong HCl blend <15%), yet remains safe for the trucks surfaces, the employees and the environment.

This composition removed as much concrete buildup as diluted hydrochloric acid, but did not harm the truck body/parts when applied properly. The concrete cleaning composition can be applied anywhere as it is biodegradable, non-fuming and non-toxic.

Some of the main features of the composition include the fact that it is biodegradable, environmentally safe, non-toxic, non-fuming and non-hazardous.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims. The invention is therefore to be understood not to be limited to the exact components set forth above.

1. A synthetic acid composition for use in industrial activities, said composition comprising:
urea and hydrogen chloride in a molar ratio of not less than 0.1:1;
a metal iodide or iodate;
an alcohol or derivative thereof; and
optionally, a phosphonic acid derivative.

2. The synthetic acid composition according to claim 1, further comprising formic acid or derivative thereof.

3. The synthetic acid composition according to claim 1, further comprising a compound selected from the group consisting of propylene glycol or derivative thereof, ethylene glycol, glycerol or a mixture thereof.

4. The synthetic acid composition according to claim 1, further comprising cinnamaldehyde or a derivative thereof.

5. The synthetic acid composition according to claim 1, wherein the urea and hydrogen chloride are in a molar ratio of not less than 0.5:1.

6. The synthetic acid composition according to claim 5, wherein the urea and hydrogen chloride are in a molar ratio of not less than 1.0:1.

7. The synthetic acid composition according to claim 38, wherein the phosphonic acid derivative is aminoalkylphosphonic salt.

8. The synthetic acid composition according to claim 7, wherein the aminoalkylphosphonic salt is amino tris methylene phosphonic acid.

9. The synthetic acid composition according to claim 1, wherein the metal iodide or iodate is cuprous iodide.

10. The synthetic acid composition according to claim 1, wherein the metal iodide or iodate is potassium iodide.

11. The synthetic acid composition according to claim 1, wherein the metal iodide or iodate is sodium iodide.

12. The synthetic acid composition according to claim 1, wherein the metal iodide or iodate is lithium iodide.

13. The synthetic acid composition according to claim 1, wherein the alcohol or derivative thereof is an alkynyl alcohol or derivative thereof.

14. The synthetic acid composition according to claim 13, wherein the alkynyl alcohol or derivative thereof is propargyl alcohol or a derivative thereof.

15. The synthetic acid composition according to claim 7, wherein the aminoalkylphosphonic salt is present in a concentration ranging from 0.25 to 1.0% w/w.

16. The synthetic acid composition according to claim 15, wherein the aminoalkylphosphonic salt is present in a concentration of 0.5% w/w.

17. The synthetic acid composition according to claim 13, wherein the alkynyl alcohol or derivative thereof is present in a concentration ranging from 0.10 to 2.0% w/w.

18. The synthetic acid composition according to claim 17, wherein the alkynyl alcohol or derivative thereof is present in a concentration of 0.25% w/w.

19. The synthetic acid composition according to claim 1, wherein the metal iodide is present in a concentration ranging from 100 to 500 ppm.

20. The synthetic acid composition according to claim 2, wherein the formic acid or a derivative thereof is selected from the group consisting of: formic acid, acetic acid, ethylformate and butyl formate.

21. The synthetic acid composition according to claim 20, wherein the formic acid or derivative thereof is present in an amount ranging from 0.05-2.0% by weight of the composition.

22. The synthetic acid composition according to claim 21, wherein the formic acid or derivative thereof is present in an amount of approximately 0.1% by weight of the composition.

23. The synthetic acid composition according to claim 2, wherein the formic acid or derivative thereof is formic acid.

24. The synthetic acid composition according to claim 3, wherein the compound selected from the group consisting of: propylene glycol or derivative thereof, ethylene glycol, glycerol or a mixture thereof, is present in a range of 0.05-1.0% by weight of the composition.

25. The synthetic acid composition according to claim 24, wherein the compound selected from selected from the group consisting of: propylene glycol or derivative thereof, ethylene glycol, glycerol or a mixture thereof is present in an amount of approximately 0.05% by weight of the composition.

26. The synthetic acid composition according to claim 4, wherein the cinnamaldehyde or derivative thereof is present in a range of 0.01-1.0% by weight of the composition.

27. The synthetic acid composition according to claim 26, wherein the cinnamaldehyde or derivative thereof is present in an amount of approximately 0.03% by weight.

28. A method for treating scale, comprising contacting the scale with the synthetic acid composition according to claim 1.

29. A method for water treatment, comprising adding the synthetic acid composition according to claim 1 to water to be treated to adjust pH of the water.

30-31. (canceled)

32. A method for treating concrete, comprising contacting concrete with the synthetic acid composition according to claim 1 to etch the concrete or to clean the concrete from equipment or a building.

33. (canceled)

34. A method for using the synthetic acid composition according to claim 1 in the food and dairy industry, comprising processing selected from the group consisting of:
contacting the synthetic acid composition with a fluid in manufacturing protein,
contacting the synthetic acid composition with a fluid in manufacturing starch,
demineralizing whey with the synthetic acid composition,
contacting the synthetic acid composition with a fluid in manufacturing casein, and
contacting ion exchange resins with the synthetic acid composition during regeneration of the ion exchange resins.

35-37. (canceled)

38. The synthetic acid composition of claim 1, comprising the phosphonic acid derivative.

39. The synthetic acid composition according to claim 38, further comprising:
formic acid or derivative thereof;
a compound selected from the group consisting of propylene glycol or derivative thereof, ethylene glycol, glycerol or a mixture thereof;
cinnamaldehyde or a derivative thereof present in a range of 0.01-1.0% by weight of the composition;
and wherein:
the urea and hydrogen chloride are in a molar ratio of not less than 0.5:1;
the phosphonic acid derivative is an aminoalkylphosphonic salt present in a concentration ranging from 0.25 to 1.0% w/w;
the alcohol or derivative thereof is an alkynyl alcohol or derivative thereof present in a concentration ranging from 0.10 to 2.0% w/w; and
the metal iodide is present in a concentration ranging from 100 to 500 ppm.

40. A method for adjusting pH of a fluid system, comprising adding the synthetic acid composition of claim 1 to the fluid system.

41. The method according to claim 29, wherein the water to be treated is alkaline effluent from water treatment and the addition of the synthetic acid composition neutralizes the alkaline effluent.
